(19) United States
(12) Patent Application Publication
(10) Pub. No.: US 2024/0410792 A1
(43) Pub. Date: Dec. 12, 2024

(54) COMPONENT EVALUATION DEVICE AND COMPONENT EVALUATION METHOD

(71) Applicant: Honda Motor Co., Ltd., Tokyo (JP)

(72) Inventors: Takayuki Ishibashi, Tokyo (JP); Takahiro Yoshii, Tokyo (JP); Shogo Shibahara, Tokyo (JP); Yudai Okabe, Tokyo (JP); Hirofumi Yabu, Tokyo (JP); Kohei Mukaihara, Tokyo (JP); Kohei Saito, Tokyo (JP)

(21) Appl. No.: 18/732,396

(22) Filed: Jun. 3, 2024

(30) Foreign Application Priority Data
Jun. 8, 2023 (JP) 2023-094792

(51) Int. Cl. G01M 99/00

(52) U.S. Cl. CPC G01M 99/00

(57) ABSTRACT

A component evaluation device includes: a processor and a memory coupled to the processor. The device is configured to perform: acquiring information regarding failure of a component input through an information input terminal after use of the component; calculating a failure occurrence rate of the component over time based on the information; and evaluating quality of a same type component of a type same as the component based on the failure occurrence rate.

### CROSS-REFERENCE TO RELATED APPLICATION

This application is based upon and claims the benefit of priority from Japanese Patent Application No. 2023-094792 filed on Jun. 8, 2023, the content of which is incorporated herein by reference.

### BACKGROUND OF THE INVENTION

### Field of the Invention

The present invention relates to a component evaluation device and a component evaluation method configured to evaluate quality of components.

### Description of the Related Art

As this type of device, conventionally, there has been known a device configured to evaluate the quality of a mounting substrate by comparing quality data obtained by quality inspection of a mounting substrate produced in the past with quality data obtained by quality inspection of a mounting substrate currently being produced (see JP2007-053264A, for example). In the device described in JP2007-053264A, when the defect rate obtained from the current quality data exceeds a predetermined defect rate obtained from the past quality data, production is temporarily suspended.

However, in the device described in JP2007-053264A, the production is not suspended until the defect rate obtained from the current quality data exceeds the predetermined defect rate obtained from the past quality data, and thus it is difficult to perform quality evaluation of a component at an early stage.

### SUMMARY OF THE INVENTION

An aspect of the present invention is a component evaluation device, including: a processor and a memory coupled to the processor. The device is configured to perform:

acquiring information regarding failure of a component input through an information input terminal after use of the component; calculating a failure occurrence rate of the component over time based on the information; and evaluating quality of a same type component of a type same as the component based on the failure occurrence rate.

Another aspect of the present invention is a component evaluation method, including the steps of: acquiring information regarding failure of a component input through an information input terminal after use of the component; calculating a failure occurrence rate of the component over time based on the information; and evaluating quality of a same type component of a type same as the component based on the failure occurrence rate.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an example of an overall configuration of a component evaluation system including a component evaluation device according to an embodiment of the present invention;

FIG. 2 is a diagram for describing failure information managed by the component evaluation device in FIG. 1;

FIG. 3 is a diagram for describing a normal range of a failure occurrence rate of a component over time managed by the component evaluation device in FIG. 1;

FIG. 4 is a diagram for describing exclusion of failure information by the component evaluation device in FIG. 1;

FIG. 5 is a flow chart illustrating an example of normal range setting process executed by the component evaluation device in FIG. 1; and

FIG. 6 is a flow chart illustrating an example of quality evaluation process executed by the component evaluation device in FIG. 1.

### DETAILED DESCRIPTION OF THE INVENTION

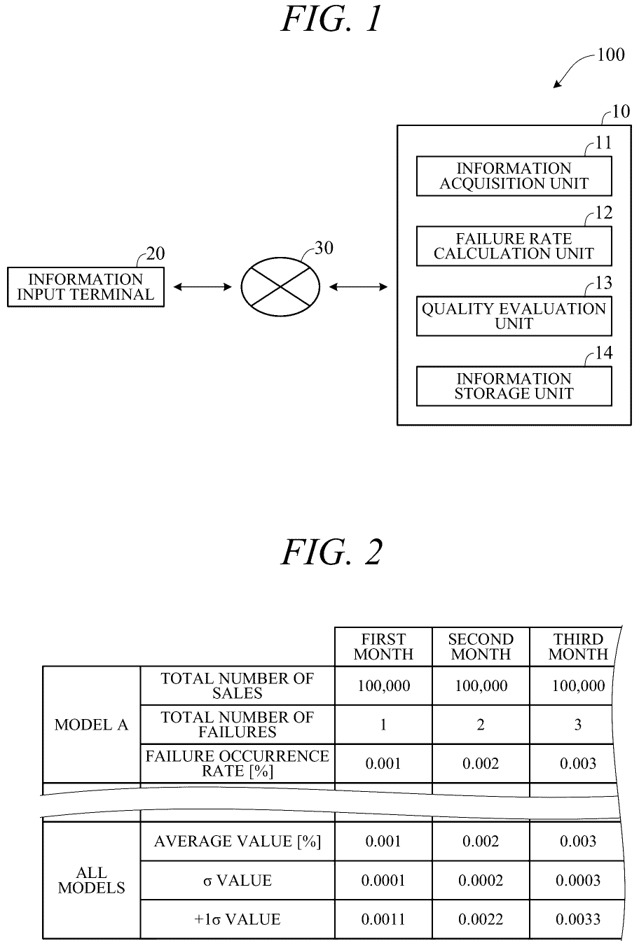

Hereinafter, an embodiment of the present invention will be described with reference to FIGS. 1 to 6. A component evaluation device according to the embodiment of the present invention evaluates quality of a specific component mounted on a product such as a vehicle, particularly a failure occurrence rate of each component after the product is manufactured and used. In a life cycle from when a product such as a vehicle is manufactured to when it is discarded, a failure occurs in each component over time. If the occurrence situation of such a failure is normal, the failed component may be repaired or replaced individually, but if it is abnormal, fundamental measures such as design change are required.

However, since the occurrence situation of such a failure varies depending on the type of component, the use period, and the like, it is difficult to evaluate whether the failure occurrence situation is normal or abnormal at an early stage. For example, among the vehicle components, a deficiency such as a malfunction or the like of a catalyst device is relatively unlikely to occur, and even occurrence in 0.01% of the catalyst devices after a predetermined use period is abnormal, whereas a deficiency such as occurrence of a steering wheel judder or the like is relatively likely to occur, and even occurrence in about 1% of the steering wheels is normal. Therefore, in the present embodiment, the component evaluation device is configured as follows so that by setting a reference value of the failure occurrence rate with the elapse of a use period in advance for each component, quality evaluation of a component of the same type as that component can be performed at an early stage.

FIG. 1 is a block diagram schematically illustrating an example of an overall configuration of a component evaluation system 100 including a component evaluation device (hereinafter referred to as device) 10 according to an embodiment of the present invention. As illustrated in FIG. 1, the component evaluation system 100 includes the device 10 and an information input terminal 20 provided in a store or the like that sells or repairs products such as vehicles. The device 10 and the information input terminal 20 are communicably connected to each other via a communication network 30 including a local area network (LAN) and a wide area network (WAN) such as the Internet.

The device 10 includes a computer including a central processing unit (CPU), a ROM, a RAM (memory), other peripheral circuits, and the like. The device 10 includes an information acquisition unit 11, a failure rate calculation unit 12, and a quality evaluation unit 13 as a functional configuration of a processor, and includes an information storage unit 14 as a functional configuration of a memory. That is, the processor of the device 10 functions as the information acquisition unit 11, the failure rate calculation unit 12, and the quality evaluation unit 13, and the memory of the device 10 functions as the information storage unit 14. The device 10 may be configured as a single server device, may be configured as a distributed server device, or may be configured as a distributed virtual server device provided on a cloud environment.

The information input terminal 20 includes, for example, equipment connectable to the communication network 30, such as a personal computer or a tablet terminal provided in a store or the like that sells or repairs products such as vehicles. To the information input terminal 20, a store staff member or the like inputs product information regarding a specification, a manufacturing place, and a use start time of a product, failure information regarding a failed component and a failure time when a product fails, and the like. The product information and the failure information input to the information input terminal 20 are transmitted to the device 10 via the communication network 30.

Product information includes, for example, information such as a model, a year of manufacture, a place of sale (destination), and a manufacturing factory (manufacturing place) as classification information necessary for classifying each product according to the type of product. Hereinafter, products having the same model, year of manufacture, destination, manufacturing place, and the like included in the classification information are referred to as products of the same “model”. That is, each component mounted on a plurality of models is a target of quality evaluation. Product information also includes information such as a manufacturing date, a shipping date, a sales date, a delivery date, and the like as information on a use start time necessary for identifying the use start time of each product according to the type of product. Product information of each product is managed in association with identification information such as a vehicle body number for identifying each product. Input of product information is not limited to the store, and may be performed at a manufacturing place such as a manufacturing factory or a place of use after delivery of the product. In this case, equipment for inputting product information is also referred to as an information input terminal 20.

Failure information includes information such as a general name (e.g., catalyst device, steering wheel, or the like) and a component number of a failed component as information necessary for identifying the failed component that is a cause when the product fails. The component number for identifying each component includes, for example, a plurality of character strings, where a part of the character strings (e.g., upper two digits or the like) represents a large classification of components and corresponds to a general name of the component. Failure information includes, for example, a repair acceptance date at which a repair request is accepted at a store or the like where a product is repaired, a failure occurrence date at which a user or the like notices a failure state of the product, and the like as information on a failure time necessary for identifying a time when a failure occurs in each product. The failure occurrence date may be a date and time identified by a self-diagnosis function of the product. Similarly to the product information, the failure information of each product is managed in association with identification information such as a vehicle body number. Failure information may be input by the user himself/herself of the product, and in this case, user equipment for inputting product information is also referred to as the information input terminal 20. When a product has a self-diagnosis function and a communication function and failure information is directly transmitted from the product to the device 10, the product itself is also included in the information input terminal 20.

The information acquisition unit 11 of the device 10 acquires product information transmitted from the information input terminal 20 when a product on which each component is mounted is manufactured or the like, and acquires failure information transmitted from the information input terminal 20 when each product is used and a failure occurs. The product information and the failure information acquired by the information acquisition unit 11 are associated with identification information such as a vehicle body number and stored in the information storage unit 14.

FIG. 2 is a diagram for describing failure information managed by the device 10, and illustrates an example of failure information for each model for a specific component (e.g., catalyst device, steering wheel, or the like). As illustrated in FIG. 2, the failure rate calculation unit 12 counts the total number of products (total number of products sold in example of FIG. 2) and the total number of failures over time for each model on the basis of the product information and the failure information acquired by the information acquisition unit 11. The total number of failures over time is the total number of failures over time from a specific point in time such as the manufacturing date of each product, and is aggregated on a monthly basis in the example of FIG. 2. In the example of FIG. 2, regarding the specific component of Model A, one failure occurred within one month from the manufacturing date, two failures occurred within two months from the manufacturing date, and three failures occurred within three months from the manufacturing date.

The failure rate calculation unit 12 further calculates a failure occurrence rate over time of each model on the basis of the total number of products and the total number of failures over time for each model. In the example of FIG. 2, the failure occurrence rate of the specific component of Model A is calculated as 0.001% from the manufacturing date to after one month, 0.002% from the manufacturing date to after two months, and 0.003% from the manufacturing date to after three months.

For a new model, the quality evaluation unit 13 evaluates the quality of a component of the same type as the component on the basis of the failure occurrence rate over time of each model calculated by the failure rate calculation unit 12 for a specific component. More specifically, the quality evaluation unit 13 calculates an average value, a standard deviation (σ value), and a sum (+1σ value) of the average value and the standard deviation of the failure occurrence rates over time of all past models on the basis of the failure occurrence rate over time for each past model.

A past model is a model that is, at the time of performing quality evaluation on a new model, already manufactured and used, whose product information and failure information have been collected, and whose failure occurrence rate over time has been calculated by the failure rate calculation unit 12. Past models may be all models including a new model, or may be all models except for the new model. Past models may be all models except for a model in which the failure occurrence situation of the component to be evaluated is abnormal or a model in which a response such as a design change is actually required. Quality evaluation of a component for a new model is performed after the new model is manufactured and used, the product information and the failure information are collected, and the failure rate calculation unit 12 calculates the failure occurrence rate over time. In addition, the quality evaluation is performed in the same period as the period of calculating the failure occurrence rate of the past model, for example, on a monthly basis.

In the example of FIG. 2, the average value of the failure occurrence rates over time of past models (all models) for a specific component is calculated as 0.001% from the manufacturing date to after one month, 0.002% from the manufacturing date to after two months, and 0.003% from the manufacturing date to after three months. The σ value is calculated as 0.0001% from the manufacturing date to after one month, 0.0002% from the manufacturing date to after two months, and 0.0003% from the manufacturing date to after three months. The +1σ value is calculated as 0.0011% from the manufacturing date to after one month, 0.0022% from the manufacturing date to after two months, and 0.0033% from the manufacturing date to after three months.

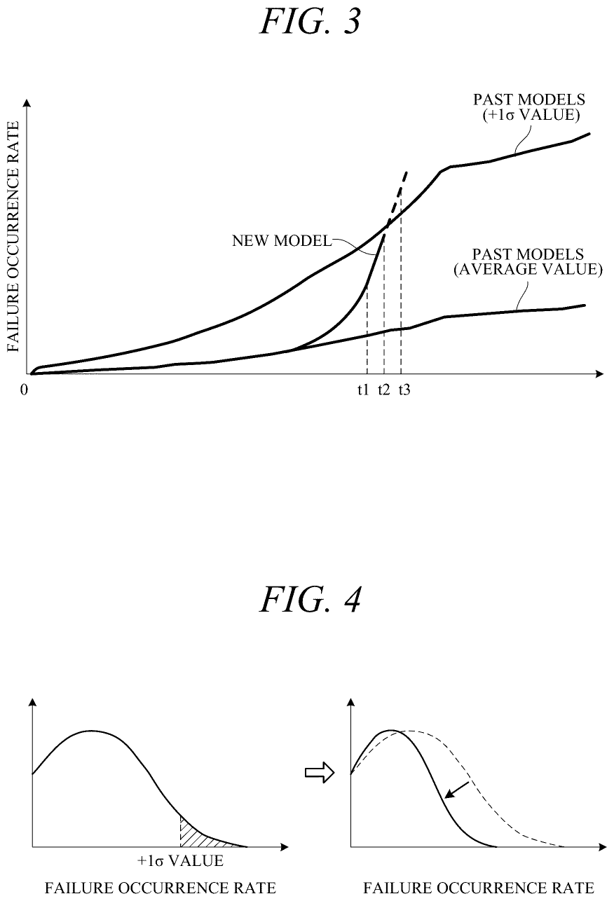

FIG. 3 is a diagram for describing a normal range of a failure occurrence rate of a component over time managed by the device 10. As illustrated in FIG. 3, the quality evaluation unit 13 sets the +1σ value of the failure occurrence rate over time of the past model as the upper limit value of the normal failure occurrence rate over time, and evaluates the quality of a component of the same type mounted on a new model on the basis of the set upper limit value. More specifically, it is determined whether or not it is predicted that the failure occurrence rate over time of the new model calculated by the failure rate calculation unit 12 exceeds the set upper limit value of the normal failure occurrence rate over time.

For example, the quality evaluation unit 13 calculates an increase rate of the failure occurrence rate of the new model calculated by the failure rate calculation unit 12 at time points t1 and t2, estimates the failure occurrence rate at subsequent time point t3 on the basis of the calculated increase rate, and determines whether or not the upper limit value of the normal failure occurrence rate is exceeded. Alternatively, the quality evaluation unit 13 may calculate the change rate of the increase rate of the failure occurrence rate at time points t1 and t2, estimate the increase rate of the failure occurrence rate at subsequent time points t2 and t3 and the failure occurrence rate at time point t3 on the basis of the calculated change rate, and determine whether or not the upper limit value of the normal failure occurrence rate is exceeded. In this manner, the upper limit value of the normal failure occurrence rate over time is set on the basis of the failure occurrence rate of the past model, and the quality evaluation of the component for the new model is performed, whereby whether or not the new model is a model that requires countermeasures can be evaluated at an early stage.

FIG. 4 is a diagram for describing exclusion of failure information by the device 10, and illustrates an example of frequency distribution of the failure occurrence rate after a predetermined use period calculated for each past model by the failure rate calculation unit 12 for a specific component. In the example of FIG. 4, the frequency distribution of the failure occurrence rate follows the normal distribution. As illustrated in FIG. 4, after calculating the average value (first average value), the σ value (first σ value), and the +1σ value (first +1σ value) of the failure occurrence rates for all past models, the quality evaluation unit 13 excludes a model whose failure occurrence rate exceeds the first +1σ value from the past models. As described above, when a model in which the failure occurrence rate of a specific component is relatively higher than that of other models is excluded, the variance of the frequency distribution of the failure occurrence rate becomes small. The quality evaluation unit 13 may calculate an average value (second average value), a σ value (second σ value), and a +1σ value (second +1σ value) of the failure occurrence rates for the remaining past models excluding models exceeding the first +1σ value, and set the second+1σ value as the upper limit value of the normal failure occurrence rate. In this case, the evaluation accuracy of the new model based on the upper limit value of the normal failure occurrence rate can be improved.

Such model exclusion may be repeated until the frequency distribution of the failure occurrence rate satisfies a predetermined condition. For example, the predetermined condition may be that the variance (σ2) of the frequency distribution of the failure occurrence rate, the magnitude (|σ|) of the standard deviation, and the Shannon entropy indicating the variation in the frequency distribution of the failure occurrence rate are equal to or less than a predetermined value.

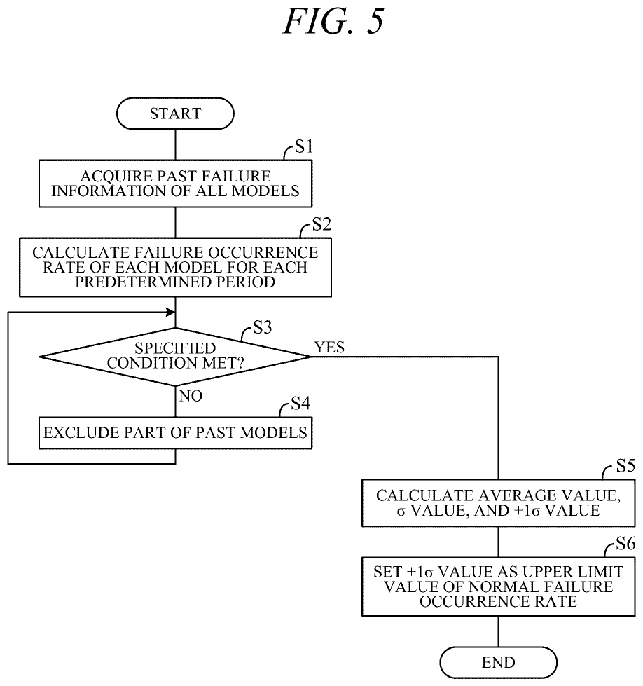

FIG. 5 is a flow chart illustrating an example of normal range setting process executed by the device 10. The process of FIG. 5 is executed when performing the quality evaluation of a specific component for a new model, and is executed before performing the first evaluation at least for the new model. As shown in FIG. 5, first, in S1 (S: processing step), the past failure information of all models stored in the information storage unit 14 is read and acquired. Next, in S2, for the specific evaluation target component, the failure occurrence rate of each model for each predetermined period is calculated based on the information acquired in S1.

Next, in S3, at a predetermined cycle, it is determined whether the frequency distribution of the failure occurrence rate calculated in S2 meets a specified condition. If S3 is negative, the process proceeds to S4, where the first average value, the first σ value, and the first +1σ value of the failure occurrence rate calculated in S2 are calculated, models exceeding the first +1σ value of the failure occurrence rate are excluded, and the process returns to S3. If S3 is affirmative, the process proceeds to S5, where the average value (second average value), the σ value (second σ value), and the +1σ value (second +1σ value) of the failure occurrence rate for each predetermined period calculated in S2 are calculated. Next, in S6, the +1σ value for each predetermined period calculated in S5 is set as the upper limit value of the normal failure occurrence rate for each predetermined period, and the process ends.

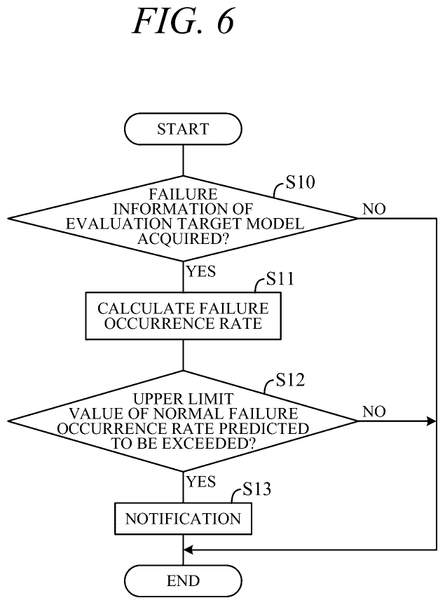

FIG. 6 is a flow chart illustrating an example of quality evaluation process executed by the device 10. The process of FIG. 6 is repeatedly executed at a predetermined cycle after the normal range setting process in FIG. 5. As shown in FIG. 6, first, in S10, it is determined whether new failure information of the specific evaluation target component for the evaluation target new model has been acquired from the information input terminal 20. If S10 is negative, the process ends. If S10 is affirmative, the process proceeds to S11, where the first average value, the failure information of the new model stored in the information storage unit 14 is read and the failure occurrence rate of the specific evaluation target component for each predetermined period is calculated. For example, if new failure information that the specific evaluation target component failed three months after the manufacturing date etc., is acquired five months after the start of manufacturing etc., of the new model, only the failure occurrence rate three months after the manufacturing date etc., is updated among the failure occurrence rates for each predetermined period.

Next, in S12, the failure occurrence rate of the new model for each predetermined period calculated in S11 and the upper limit value of the normal failure occurrence rate for each predetermined period set in the normal range setting process (S6 in FIG. 5) are compared to determine whether it is predicted to exceed the upper limit value. For example, five months after the start of manufacturing etc., of the new model, the increase rate of the failure occurrence rate is calculated based on the failure occurrence rates four and five months after the start of manufacturing etc., and based on the calculated increase rate, the failure occurrence rate six months after the start of manufacturing etc., is estimated to determine whether it exceeds the upper limit value of the normal failure occurrence rate. If S12 is negative, the process ends. If S12 is affirmative, the process proceeds to S13, where it is notified that measures such as design changes for the specific component of the new model may be necessary, and the process ends. Notification can be made, for example, by sending a notification to a pre-registered email address.

In this way, by monitoring the changes over time in the failure occurrence rate of a new product for each predetermined period and evaluating whether they are normal, it becomes possible to perform an early quality evaluation of a specific component in the new product (S10 to S12 in FIG. 6). Furthermore, by performing a relative evaluation based on the failure occurrence rates of past models, it becomes possible to perform appropriate evaluation for new models (S1 to S6 in FIGS. 5, S10 to S12 in FIG. 6). Additionally, by excluding models from the past that exceed the first +lo value of the failure occurrence rate, it becomes possible to further improve the evaluation accuracy (S3 to S4 in FIG. 5).

According to the present embodiment, the following effects can be achieved.
(1) The device 10 includes: the information acquisition unit 11 that acquires information regarding failure of each component after use of a product on which the component is mounted; the failure rate calculation unit 12 that calculates a failure occurrence rate of each component over time on the basis of the information acquired by the information acquisition unit 11; and the quality evaluation unit 13 that evaluates quality of a component of the same type as each component on the basis of the failure occurrence rate calculated by the failure rate calculation unit 12 (FIG. 1). That is, for a specific component, whether or not a failure occurrence rate over time of a new product is normal is evaluated on the basis of a failure occurrence rate over time of a past product. As described above, for a new product, by monitoring the failure occurrence rate over time, in other words, a change in the failure occurrence rate over time and evaluating whether or not the failure occurrence rate is normal, it is possible to evaluate the quality of a specific component in the new product at an early stage and take necessary countermeasures such as a design change.
(2) The component is mounted on a plurality of models (FIGS. 2 and 3). The failure rate calculation unit 12 calculates a failure occurrence rate for each past model (FIG. 5). The quality evaluation unit 13 evaluates the quality of the same type of component mounted on a new model on the basis of the failure occurrence rate for each past model calculated by the failure rate calculation unit 12 (FIG. 6). Among a plurality of models, there may be a model in which a failure occurrence rate of a specific component is relatively higher than that of other models, and for such a model, a countermeasure such as a design change may be required after the start of sales. By performing the relative evaluation on the basis of the failure occurrence rate for each past model, it is possible to appropriately evaluate the possibility that the new model is a model that requires such a countermeasure.
(3) The quality evaluation unit 13 sets the upper limit value of the normal failure occurrence rate on the basis of the failure occurrence rate for each past model, and evaluates the quality of the same type of component mounted on a new model on the basis of the set upper limit value (FIGS. 2, 3, 5, and 6). This can facilitate evaluation.
(4) The quality evaluation unit 13 calculates an average value and a σ value of the failure occurrence rates for each past model, and sets a sum (+1σ value) of the calculated average value and the σ value as an upper limit value (FIGS. 2 and 5). As a result, the evaluation accuracy can be improved.
(5) The quality evaluation unit 13 calculates the first average value and the first σ value of the failure occurrence rates for each past model, excludes the failure occurrence rate exceeding the sum (first +1σ value) of the calculated first average value and the first σ value, calculates the second average value and the second σ value of the failure occurrence rates for each past model, and sets the sum (second +1σ value) of the calculated second average value and the second σ value as the upper limit value (FIGS. 4 and 5). As a result, the evaluation accuracy can be improved even more.

In the above embodiment, the example has been described in which the quality evaluation of the same type of component for a new model is performed on the basis of the failure occurrence rate of the past model with a product having the same specification such as the model, the year of manufacture, the destination, and the manufacturing place as the same model, but the quality evaluation of the same type of component is not limited to such an example. For example, quality evaluation of the same type of component for a new product may be performed on the basis of a failure occurrence rate of a past product having the same specification.

In the above embodiment, an example in which the failure occurrence rate on a monthly basis is used has been described, but the failure occurrence rate over time is not limited to such an example. For example, a failure occurrence rate in units of days, weeks, or months may be used. Alternatively, a physical quantity corresponding to the operating time of the product may be used as a reference of the lapse of time. For example, when evaluating a vehicle component, the failure occurrence rate for each predetermined distance travel may be used with the travel distance of the vehicle as a reference of the lapse of time.

In the above embodiment, although the present invention has been described as a component evaluation device, the present invention can also be applied as a component evaluation method. Specifically, the component evaluation method includes the steps of: acquiring the information regarding failure of a component after use of the component (S1 in FIG. 5, and S10 in FIG. 6); calculating the failure occurrence rate of the component over time based on the acquired information (S2 in FIG. 5, and S11 in FIG. 6); and evaluating quality of a same type component of a type same as the component based on the calculated failure occurrence rate (S12 in FIG. 6), each executed by a computer.

The above embodiment can be combined as desired with one or more of the aforesaid modifications. The modifications can also be combined with one another.

According to the present invention, it becomes possible to perform an early quality evaluation of components.

Above, while the present invention has been described with reference to the preferred embodiments thereof, it will be understood, by those skilled in the art, that various changes and modifications may be made thereto without departing from the scope of the appended claims.

1. A component evaluation device, comprising:
a processor and a memory coupled to the processor, wherein
the processor is configured to perform:
acquiring information regarding failure of a component input through an information input terminal after use of the component;
calculating a failure occurrence rate of the component over time based on the information; and
evaluating quality of a same type component of a type same as the component based on the failure occurrence rate.

2. The component evaluation device according to claim 1, wherein
the component is mounted on a plurality of models, wherein
the processor:
calculates the failure occurrence rate for each past model; and
evaluates the quality of the same type component mounted on a new model based on the failure occurrence rate for each past model.

3. The component evaluation device according to claim 2, wherein
the processor:
sets an upper limit value of a normal failure occurrence rate based on the failure occurrence rate for each past model; and
evaluates the quality of the same type component mounted on the new model based on the upper limit value.

4. The component evaluation device according to claim 3, wherein
the processor:
calculates an average value and a standard deviation of the failure occurrence rate for each past model; and
sets a sum of the average value and the standard deviation as the upper limit value.

5. The component evaluation device according to claim 3, wherein
the processor:
calculates a first average value and a first standard deviation of the failure occurrence rate for each past model;
excludes the failure occurrence rate exceeding a sum of the first average value and the first standard deviation;
calculates a second average value and a second standard deviation of the failure occurrence rate for each past model; and
sets a sum of the second average value and the second standard deviation as the upper limit value.

6. The component evaluation device according to claim 5, wherein
the processor repeats exclusion of the failure occurrence rate until a frequency distribution of the failure occurrence rate satisfies a predetermined condition.

7. The component evaluation device according to claim 1, wherein
the processor notifies a quality evaluation result of the same type component.

8. A component evaluation method, comprising the steps of:
acquiring information regarding failure of a component input through an information input terminal after use of the component;
calculating a failure occurrence rate of the component over time based on the information; and
evaluating quality of a same type component of a type same as the component based on the failure occurrence rate.
